(19) United States
(12) Patent Application Publication
(10) Pub. No.: US 2017/0357212 A1
(43) Pub. Date: Dec. 14, 2017

(54) CONSTRUCTIVE ARRANGEMENT APPLIED IN PORTABLE HOLOGRAPHIC DEVICE

(71) Applicant: Paul de Tharso Lazzuri Guarini, Sao Bernardo do Campo (BR)

(72) Inventor: Paul de Tharso Lazzuri Guarini, Sao Bernardo do Campo (BR)

(21) Appl. No.: 15/298,447

(22) Filed: Oct. 20, 2016

(30) Foreign Application Priority Data
Jun. 9, 2016 (BR) BR 20 2016 013308

(51) Int. Cl. G03H 1/22; G03H 1/00; G03H 1/08

(52) U.S. Cl. CPC G03H 1/2205; G03H 1/0891; G03H 1/0005; G03H 2001/2215; G03H 2001/0055; G03H 2227/02; G03H 2227/05

(57) ABSTRACT

Utility model patent consisting of a structure (1) made of specific materials assembled so as to allow a proper view of the holographic content in its interior, in such a manner that the structure (1) has two parts: a lit up stage (2), the lights of which are powered by portable batteries, and a stage cover, inside of which there is an flat acetate sheet (3) in a specific angle so that the holographic contents, treated by the software, are displayed mid-air for those who use such device; when the software (app) starts up, users may choose the contents they desire to watch and then put the cell phone (4) within the structure of the portable holographic device (1), through an opening (5), in an area called projection pool, so that the digital content displayed on the cell phone interacts with the sheet creating holographic images.

### FIELD OF APPLICATION

This report describes the utility model patent for a new holographic device, namely, a portable holographic device with a new constructive arrangement applied, with an innovative design and equipped with significant technological and functional improvements, under the most modern engineering concepts and in accordance with the required standards and specifications, having its own features and provided with fundamental requirements of novelty and inventive act, resulting in a series of actual and extraordinary technical, practical and economic advantages.

### BACKGROUND OF THE INVENTION

Holographic technology, as a synonym to mid-air projection of digital content, has proven to be appropriate to display tri-dimensional objects in contrast to other bi-dimensional display equipment, with different screen formats and sizes. For this reason, said technology has achieved a great deal of presence in the marketing and entertainment industry, such as in musical concerts, allowing to work with the digital holographic content so as to recreate or revive an already deceased artist sharing the stage with other artists or even combine real and virtual elements on stage. However, even after two decades of constant development of holographic projects and works, consistently delivered to some events, the high cost of such technology makes unfeasible to date for that to benefit other fields of knowledge and action. There is also the issue of the access to said technology, that today is present only in companies specialized in holography and that, in general, also sell it to other companies, making it difficult for the final user to buy and use the resource with low investment and a small physical area. Another issue relates the need some knowledge have in terms of representing some tri-dimensional objects in a classroom, such as an engine, the human body, a solid geometric figure, among others, which are generally represented by images in perspective, in a chalk board for instance.

In this sense some inventors idealized the products object of the patent documents below, but did not observe the portability details.

### Technique Status

Patent document PI 0700313-7, filed on Jan. 16, 2007, titled “pista de dança decorativa” (decorative dance floor), concerns a decorative dance floor that, according to its general features, has as its basic principle the creation of dance floors customized with holographic vinyl drawings (4), which may be used in party and event halls, such as: nightclubs, birthday parties, weddings, among others. Having a specific and different design the floors can be manufactured in specific formats and themes for every event, each with custom drawings and reflective and/or holographic details (4), which in contact with the lighting, transmits plenty of light, brightness and vibrant colors, thus creating a dance floor (1) and a very pleasant and nice decoration for a party or event.

Patent document PI 0612417-8, filed on May 5, 2006, titled “dispositivo para a reconstrução de cenas tridimensionais com hologramas de video” (device for reconstruction of three-dimensional scenes by video holograms), consists of an optical focusing means that that emits sufficiently coherent light from a light means to the eyes of at least one observer through a spatial light modulator coded with the holographic information. The device is composed by many illumination units to light the surface of the spatial light modulator (SLM); each unit includes a focusing element and a light means that emits sufficiently coherent light so that each illumination unit light a lit area separate from the surface and in which the focusing element and the light means are arranged in such a way that the light emitted by the light is directed next to or to the observer's eyes.

Patent document MU 8402414-3, filed on Jun. 1, 2004, titled “projetor de imagens e comunicação visual ampliados” (enlarged image and visual communication projector), consists of a device consisting of a set of tools for the projection of advertising images in movie theaters or projection screens, and also flat surfaces in places intended to show the audience advertisements and other information materials. Said utility model is a set that has, in addition to the convenience of transportation and changes of short or long advertisements in cinematographic screens in proper places, may be easily taken from one place to another with lower production costs compared to the enormous cost of the 35 mm film, fixed signs such as billboards, or projections in sports, social and cultural events. Thus transforming a slide presentation (analogical or digital) of an advertising campaign to be projected in an enlarged fashion on any flat surface capable of receiving a clear image projection.

By examining the documents above, and knowing the technique status, as we will further discuss, none of which has in full the constructive characteristics of the portable holographic device object hereof.

In view of this, studies have been conducted over time to eliminate all those issues and difficulties and, as a result, this holographic device has been developed allowing for the creation of a new piece of equipment, through which it is possible to project mid-air holographic images through a portable device, thus having an affordable integrated product, minimizing costs, assembly time and labor costs, in addition to a precise assembly, with the best results and high safety standards.

Therefore, this utility model patent has as purpose to provide a holographic solution to solve the issues above and thus help many fields of activity in the market, as well as to innovate in the portable digital and visual communication field compared to the now traditional bi-dimensional image and video resources.

These and other objectives shall be met with a cross-platform layout capable of reproducing digital content mid-air; the device consisting of 3 parts, the first of which is formed by a physical structure, the second an intelligent mobile device (such as a smartphone), and the last an application that may run in the mobile device to reproduce the holographic content, developed for the Android (Google's), iOS (Apple's) and Windows Phone (Microsoft's) operating systems, so that the mobile device used be that of the final client or consumer who acquires the product, thus solving the problem of the high investment necessary to count on holographic resources. The product resulting from the present utility model aims at the low cost and the trade and distribution to final users around the globe, thus solving the problem of access to the holography.

### BRIEF DESCRIPTION OF DRAWINGS

To complement the present description so as to obtain a better understanding of its characteristics, and in accordance with its practical implementation, attached hereto is a set of drawings that illustrates, without limiting the invention, what follows:

FIG. 1 represents a view in perspective of the portable device object hereof;

FIG. 2 represents a section view in elevation of the portable device object hereof;

FIG. 3 represents a front view of the portable device object hereof;

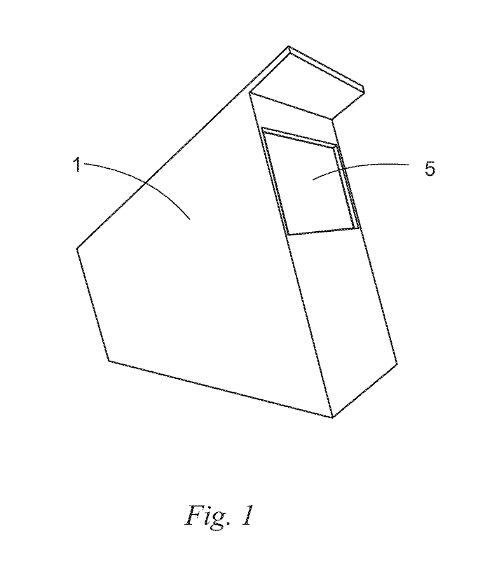

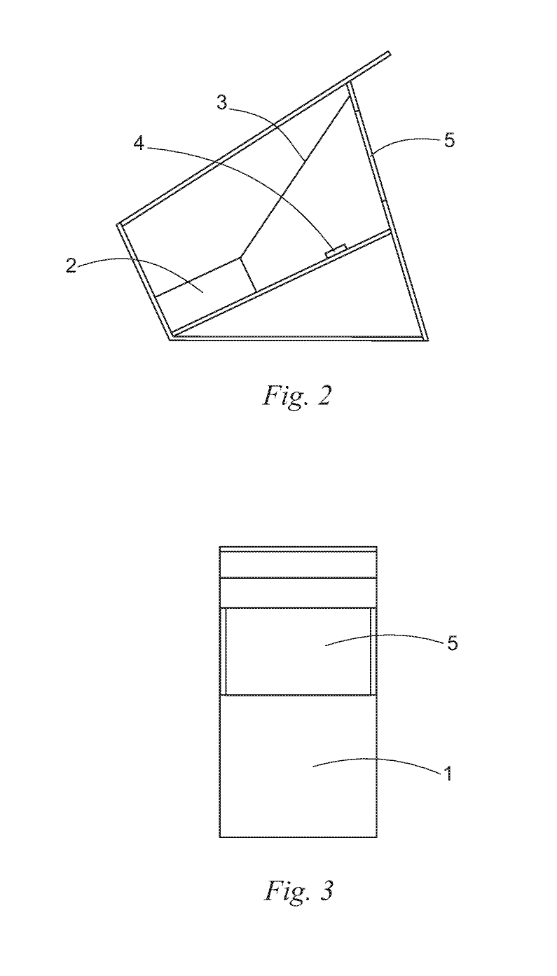

### DETAILED DESCRIPTION OF THE UTILITY MODEL

In accordance with said figures, and its details, this patent consists of a structure (1) made of specific materials assembled so as to allow a proper view of the holographic content in its interior. The structure (1) has two parts: a lit up stage (2), the lights of which are powered by portable batteries, and a stage cover, inside of which there is a flat acetate sheet (3) in a specific angle so that the holographic contents, treated by the software, are displayed mid-air for those who use such device. When the software (app) starts up, users may choose the contents they desire to watch and then put the cell phone (4) within the structure of the portable holographic device (1), through an opening (5), in an area called projection pool, so that the digital content displayed on the cell phone interacts with the sheet creating holographic images. With the system fully assembled and working in the form of a product, its operation will last as long as the cell phone battery and the batteries that light it internally do, having therefore both autonomy and portability features.

To our knowledge there is no portable holographic device that combines all the building and functional characteristics above, and which is or has been, whether directly or indirectly, effective compared to the device object hereof.

It is obvious for the insiders that while we describe the preferred execution of the constructive arrangement here introduced, any modifications and/or changes must be understood as made within the scope of the utility model patent, thus perfectly meeting the criteria that define it, that is, the combination and modifications of well-known characteristics into a new shape or layout, involving the inventive act, resulting in a functional improvement regarding its use or manufacture.

What is claimed is:

1. CONSTRUCTIVE ARRANGEMENT APPLIED IN PORTABLE HOLOGRAPHIC DEVICE consisting of a structure (1) made of specific materials assembled so as to allow a proper view of the holographic content in its interior, in such a manner that the structure (1) has two parts: a lit up stage (2), the lights of which are powered by portable batteries, and a stage cover, inside of which there is an flat acetate sheet (3) in a specific angle so that the holographic contents, treated by the software, are displayed mid-air for those who use such device; when the software (app) starts up, users may choose the contents they desire to watch and then put the cell phone (4) within the structure of the portable holographic device (1), through an opening (5), in an area called projection pool, so that the digital content displayed on the cell phone interacts with the sheet creating holographic images.
